(19) United States
(12) Patent Application Publication
(10) Pub. No.: US 2005/0002043 A1
(43) Pub. Date: Jan. 6, 2005

(54) Method for centering an optical transducer element, and optical transducer element for carrying out the method

(75) Inventor: Paul-Wilhelm Braun, Troisdorf (DE)

Correspondence Address: DARBY & DARBY P.C., P. O. BOX 5257, NEW YORK, NY, 10150-5257, US

(73) Assignee: PWB-Ruhlatec Industrieprodukte GmbH, Seebach (DE)

(21) Appl. No.: 10/853,776

(22) Filed: May 24, 2004

(30) Foreign Application Priority Data
May 23, 2003 (EP) 03011738.6

(51) Int. Cl. G01B 11/00

(52) U.S. Cl. 356/614; 250/234

(57) ABSTRACT

An optical transducer element in the form of a circular pulse raster disk or a pulse raster ruler mounted on a drive shaft, a tool carriage, a sliding stage, or a linearly movable position transducer has a peripheral edge running through a sensor gap of a transducer device for detecting at least one of a movement and a position. The optical transducer element is installed, centered and adjusted by: pre-positioning the optical transducer element in a preliminary position where the peripheral edge is located outside the sensor gap, and laterally sliding the optical transducer element into a centered fine-adjustment position where the peripheral edge reaches into said sensor gap.

### BACKGROUND OF THE INVENTION

The invention relates to a method for positioning or centering optical transducer elements in the form of pulse raster disks or pulse raster rulers on drive shafts, tool carriages and/or sliding stages as well as on vertically or horizontally movable position transducers, wherein the optical transducer elements run edgewise through the sensor gap of a device for detecting a movement or position. The invention further relates to an optical transducer element of a suitable configuration so that it can be positioned in accordance with the inventive method.

An optical transducer element of this type has to meet stringent requirements in respect to the accuracy of the positioning and the quality of the resolution as well as the accuracy of functioning when there are fluctuations in temperature, pressure and humidity. Since large-scale production parts are involved, design concepts are required that are production-oriented, characterized by a minimal component count and by selecting components that are as simple and as fail-safe as possible. In other words: the design of the transducer element needs to be conducive to a quick and reliable adjustment process which delivers the required precision even under difficult assembly conditions. Moreover the transducer element has to be producible in an automated manufacturing process that provides a high level of assurance.

Pulse raster disks are generally fastened on a rotating shaft by means of a hub. Either transparent pulse raster disks or reflecting pulse raster disks are used. In the case of a transparent disk, the light beam emitted by a light source on one side of the raster disk is chopped into light pulses when the disk is rotated. The light pulses are received by a sensor element positioned on the opposite side of the pulse raster disk. In the case of the reflecting pulse raster disks, the light source and the light sensor are positioned on the same side of the pulse raster disk, usually parallel to the rotation axis, so that a scanning of the pulse raster disk and pulse raster ruler respectively can take place in the most confined space.

More details on this concept are described in the utility models DE 29504883 U1 and in DE 10016959.7 (Applicant: PWB Ruhlatec Industrieprodukte GmbH). In order to simplify their adjustment, optical transducer elements can be combined in an assembly unit as described for example in the utility model DE 20120932 U1 (Applicant: PWB Ruhlatec Industrieprodukte GmbH), where a sensor/emitter unit 9 (see FIG. 1 of DE 20120932 U1) in U-shape is placed on a printed circuit board 5 which is fastened to the underside of the motor 1. The pulse raster disk is positioned on the shaft-end 2 of an electric motor 1 and its outside border area runs through the gap of the U-shaped sensor/emitter unit 9. This arrangement suffers from installation problems that can be described as follows:

The precision of the optical transducer element depends essentially on the position accuracy of the pulse raster disk on the drive shaft and on the position of the sensor/emitter unit on the printed circuit board. A variety of soldered joints are to be made on the printed circuit board. The properties and position accuracy of the materials within the area reached by the soldering heat are negatively affected by the high temperature. Moreover the production can only be automated through a very expensive process in which the process assurance is put in question due to a large number of production steps.

### OBJECT OF THE INVENTION

The objects of the present invention is therefore:
a) to develop a method of positioning an optical transducer element, and
b) to develop an optical transducer element of a suitable configuration so that a pulse raster disk or pulse raster ruler can be positioned and centered by the inventive method with a high degree of accuracy on a drive shaft, tool carriage and/or a sliding stage as well as on a vertically or horizontally movable position transducer.

The aim for the new method and the new optical transducer element is to provide a technically simple way of realizing an automated large-scale production in which the reject rate is minimal (i.e., virtually zero) and which can be used to produce parts of the smallest dimensions.

### SUMMARY OF THE INVENTION

According to the invention, this foregoing task is solved through the features detailed in the patent claims. It is shown that in the design of the optical transducer elements according to the invention, the centering can be carried out with high precision in a two-step assembly method. The new method and the new transducer element ensures that the harmful influence from the heat produced by the soldering process can be safely avoided. The process a can be increased by the straight feed movements and for the first time an automation can be achieved with low construction costs.

### BRIEF DESCRIPTION OF THE DRAWINGS

The invention will be explained in more detail below through several examples that are illustrated in the drawings, wherein

FIG. 1 represents a device incorporating the optical transducer element according to the invention in the assembled state,

FIG. 2 represents an optical transducer according to the invention with element with an elongated mounting hole, and

FIG. 3 represents an optical transducer element with a barbell-shaped mounting hole.

### DETAILED DESCRIPTION OF PREFERRED EMBODIMENTS

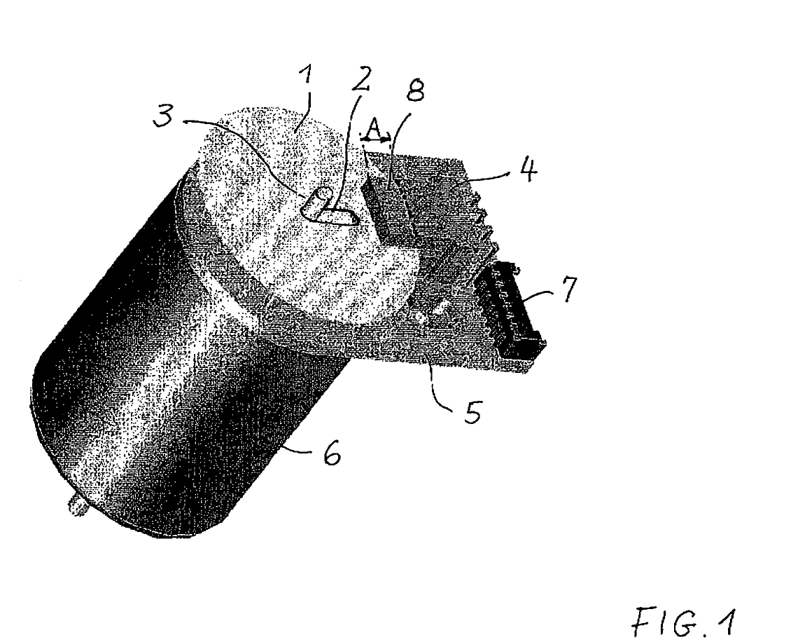

In FIG. 1 an optical transducer element 1 is shown with an opening 2 for fastening on to the drive shaft 3. To the side of the transducer element there is a sensor/emitter unit 4 which is fastened on a printed circuit board 5. The printed circuit board 5 is seated on the flange side of an electric motor 6 which has contact with a plug connector 7 through soldered joints (not shown).

The pulse raster disk that is used as an optical transducer element is positioned and centered on the shaft 3 relative to the sensor/emitter unit 4. The centering is to be done in such a way that absolutely constant measuring conditions exist in a sensor gap 8 of the sensor/emitter unit 4, in order that the code marks on the pulse raster disk will not produce any pulse fluctuations as they run through of the sensor gap 8.

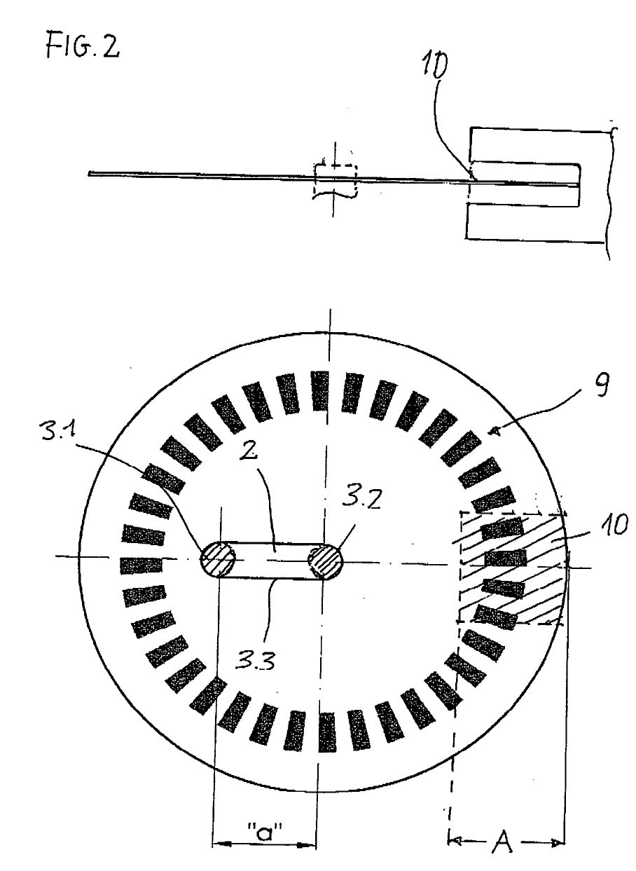

The pulse raster disk by itself is shown in FIG. 2. The pulse raster consists of rotating code markers 9 arranged along a circumference at constant intervals which were applied in a photo-optical process with an accuracy of better than one millionth of a meter.

FIG. 2 further shows a scanning zone 10 with a width A—also referred to as “sensor projection area” 10 which has the same coverage as the sensor gap 8 in FIG. 1. The light signal being sent out from the emitter part of the sensor/emitter unit is converted by the band of rotating markers 9 into electrical pulses.

The pulse raster disk in FIG. 2 has a slotted hole 2 for the mounting of the disk on the motor shaft 3. The extreme positions of the motor shaft in the slotted hole are indicated as 3.1 for the pre-positioning of the disk on the shaft and 3.2 for the centered adjustment position. The length a of the transfer guide section that connects the pre-positioning part 3.1 to the centered adjustment part of the opening corresponds to the width A of the sensor projection area 10, which in turn is equal to the entry depth of the disk into the sensor gap.

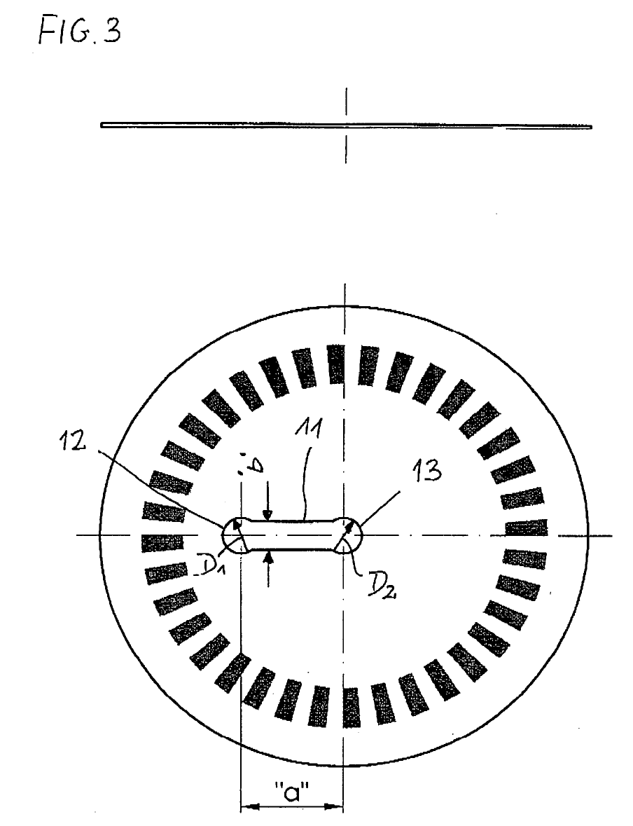

FIG. 3 shows from above, analogous to FIG. 2, a pulse raster disk, wherein the opening is shown as barbell-shaped hole 11. This design provides an optimal centering of the new optical transducer element and simultaneously ensures a positive seating in either of the end positions. The positive seating is attained by the fact that the transfer guide section between the pre-positioning part 12 and the centered adjustment part 13 has a narrower width b than either of the respective diameters D1, D2 of the pre-positioning part 12 or the centered adjustment part 13 of the barbell-shaped hole 11.

The design examples shown in FIGS. 1 to 3 illustrate the simplicity of the inventive configuration. The feed movement of the pulse raster disk from the preliminary to the centered adjustment position runs in a straight line, so that an automatic production is simple to realize. The production processes for the illustrated embodiments of the invention can be easily optimized in a way that provides a high level of process assurance.

1. A method for positioning an optical transducer element comprising one of a circular pulse raster disk and a pulse raster ruler on a supporting element comprising one of a drive shaft, a tool carriage, a sliding stages, and a linearly movable position transducer, wherein the optical transducer element has a peripheral edge running through a sensor gap of a transducer device for detecting at least one of a movement and a position, the method comprising the steps of:
pre-positioning the optical transducer element in a preliminary position where said peripheral edge is located outside said sensor gap, and
laterally sliding the optical transducer element into a centered fine-adjustment position where said peripheral edge reaches into said sensor gap.

2. The method of claim 1, wherein the optical transducer element is configured with a guide feature and the lateral sliding into the centered fine-adjustment position is guided along said guide feature.

3. The method of claim 1, wherein the step of sliding the optical transducer element into the fine-adjustment position is followed by firmly attaching the optical transducer element in the centered fine-adjustment position to the supporting element through one of a form-locked connection and a force-locked connection.

4. The method of claim 1, wherein the optical transducer element is a circular pulse raster disk and the guide feature comprises a slot-shaped hole that runs radially from the preliminary position to the centered fine-adjustment position.

5. The method of claim 4, wherein the centered fine-adjustment position is located at the center of the pulse raster disk, wherein the slot-shaped hole has a transfer guide section connecting the preliminary position to the centered fine-adjustment position, and wherein said slot-shaped hole has a narrower width in said transfer guide section than in either of the preliminary position and the centered fine-adjustment position.

6. An optical transducer element with an opening adapted for fastening the optical transducer element onto a supporting element comprising one of a drive shaft, a tool carriage, a sliding stage, and linearly movable position transducer, wherein the optical transducer element has a peripheral edge running through a sensor gap of a transducer device for detecting at least one of movement and a position, and wherein said opening has a pre-positioning part and a centered adjustment part located at a distance from each other that is at least equal to an entry depth of said peripheral edge into said sensor gap.

7. The optical transducer element of claim 6, wherein the centered adjustment part is configured with one of a form-locking fit and a force-locking fit for fastening the optical transducer element onto the supporting element.

8. The optical transducer element of claim 6, wherein the supporting element comprises a motor shaft.

9. The optical transducer element of claim 6, wherein the pre-positioning part is connected to the centered adjustment part by a transfer guide section of narrower width than either of the pre-positioning part and the centered adjustment part, and wherein said transfer guide section has a length at least equal to said entry depth.

10. The optical transducer element of claim 9, wherein the centered adjustment part, the transfer guide section and the pre-positioning part together form a barbell-shaped opening.
